(19) United States
(12) Patent Application Publication
(10) Pub. No.: US 2008/0004805 A1
(43) Pub. Date: Jan. 3, 2008

(54) Method and systems for locating source of computer-originated attack based on GPS equipped computing device

(75) Inventor: James Trent McConnell, Keller, TX (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Corporate Services Group Inc.

(21) Appl. No.: 11/477,852

(22) Filed: Jun. 30, 2006

(51) Int. Cl. G01C 21/32

(52) U.S. Cl. 701/213; 701/211

(57) ABSTRACT

Systems and methods for locating sources of, or vulnerabilities susceptible to, computer-originated attacks based on GPS devices. In one aspect, methods and systems include receiving threat data or vulnerability data, retrieving GPS data, correlating the threat data or the vulnerability data with the GPS data to create map data, and generating a map, based on the map data, displaying a geographical location of the source of, or the vulnerability susceptible to, a computer-originated attack based on a GPS device.

### RELATED APPLICATIONS

The present application relates to co-pending U.S. patent application Ser. No. 10/916,872, entitled “GEOGRAPHICAL VULNERABILITY MITIGATION RESPONSE MAPPING SYSTEM,” Attorney Docket No. 03-5008; co-pending U.S. patent application Ser. No. 10/916,873, entitled “GEOGRAPHICAL INTRUSION RESPONSE PRIORITIZATION MAPPING SYSTEM,” Attorney Docket No. 03-5009; co-pending U.S. patent application Ser. No. ______, entitled “METHODS AND SYSTEMS FOR GEOGRAPHICAL INTRUSION RESPONSE PRIORITIZATION MAPPING THROUGH AUTHENTICATION AND FLIGHT DATA CORRELATION,” Attorney Docket No. 05-5012; co-pending U.S. patent application Ser. No. ______, entitled “METHODS AND SYSTEMS FOR GEOGRAPHICAL INTRUSION RESPONSE PRIORITIZATION MAPPING THROUGH AUTHENTICATION AND BILLING CORRELATION,” Attorney Docket No. 05-5014; and co-pending U.S. patent application Ser. No. ______, entitled “METHODS AND SYSTEMS FOR GEOGRAPHICAL INTRUSION RESPONSE PRIORITIZATION MAPPING THROUGH AUTHENTICATION CALLER ID AND TELECOM BILLING CORRELATION,” Attorney Docket No. 05-5015, all of which are expressly incorporated herein by reference in their entirety.

### TECHNICAL FIELD

The present invention relates generally to methods and systems to geographically map sources of, or vulnerabilities susceptible to, computer-originated attacks based on GPS equipped computing devices.

### BACKGROUND

A digital or cyber attack may take the form of a direct attack, an introduction of malicious software such as virus and worm, or other intrusion generated by a computing device incorporating a Global Positioning System (“GPS”) receiver. Accordingly, a PDA, a Smartphone, or a laptop with embedded and/or integrated GPS capabilities can be a source of a computer-originated attack, for example, a computer-triggered attack to remotely activate explosives.

A GPS device may be used to trigger a computer-originated attack in many ways. In one scenario, a GPS device may initiate a computer-originated attack directly, for example, by starting a digital or cyber attack. Alternatively, a GPS device, when vulnerable, may be at the receiving end of a first digital or cyber attack. Once the vulnerable GPS device is compromised, it may then fall under the influence of the first digital or cyber attack and itself initiate a computer-originated attack.

Fortunately, a GPS device may capture its location information via a protocol such as National Marine Electronics Association (“NMEA”) 0183. The captured location information can then be transmitted via another protocol such as TCP or UDP to an incident response environment. For example, an existing security software vendor, such as Antivirus, may identify a digital or cyber attack, detect that the device is also receiving GPS information, and subsequently transmit the attack information and GPS information back to an incident response environment.

Therefore, response resources can be directed to a physical location of a GPS device. In practice, this requires extensive efforts to correlate existing threat data or vulnerability data with GPS data collected and subsequently transmitted, based on a connected or embedded GPS, thus reducing response time similar to a physical disaster or attack. For example, most current responses to an intrusion or vulnerability require manual review of TCP/IP switch information, manual drawing of network “maps” and, most importantly, trying to mitigate an intrusion or vulnerability in a sequential order.

These response schemes do not allow for an organization's management or intrusion response team to focus process or human resources on the major point of attack. In particular, current response schemes do not allow an organization's management to easily identify the geographical location of the problem(s) or the location(s) at which resources are most needed. Furthermore, current response schemes do not allow an organization's management or response team timely access to geographical view(s) of the location of the intrusions or vulnerabilities, together with information relating to the status or progress of the response to the intrusions or vulnerabilities. In other words, intrusion response involving deployment of technical and/or human resources is done on an ad hoc basis, following the intrusions instead of utilizing a geographical view to prioritize these technical or human resources.

Consistent with the invention, systems and methods are provided to locate sources of, or vulnerabilities susceptible to, computer-originated attacks based on GPS equipped computing devices. Using a basic “pushpin” mapping or demographic data mapping, the intrusions and/or vulnerabilities may be displayed on a map. An organization's management or intrusion response team may then be graphically presented with a pictorial view of where best to send human resources or implement other controls such as virtual fences.

### SUMMARY

Consistent with the invention, systems and methods disclosed herein locate sources of computer-originated attacks based on GPS equipped computing devices. In one aspect, methods and systems include receiving threat data, retrieving GPS data, correlating the threat data with the GPS data to create map data, and generating a map, based on the map data, displaying a geographical location of the source of a computer-originated attack.

Other methods and systems consistent with the invention locate vulnerabilities susceptible to computer-originated attacks based on GPS equipped computing devices. In one aspect, method and systems include receiving vulnerability data, retrieving GPS data, correlating the vulnerability data with the GPS data to create map data, and generating a map, based on the map data, displaying a geographical location of the vulnerability susceptible to a computer-originated attack.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments.

FIG. 1 is a block diagram of an exemplary environment in which systems and methods consistent with the present invention may be implemented;

FIG. 2 is a block diagram of an exemplary embodiment of a mapping system;

FIG. 3 is a flowchart of an exemplary method for locating a source of a computer-originated attack based on a GPS equipped computing device;

FIG. 4A is a block diagram of an exemplary method for locating a source of a computer-originated attack based on a GPS equipped computing device wherein the network-based system does not communicate directly with the GPS device;

FIG. 4B is a block diagram of an exemplary method for locating a source of a computer-originated attack based on a GPS equipped computing device wherein the network-based system communicates directly with the GPS device;

FIG. 5 is an exemplary screenshot of records in a threat database;

FIG. 6 is an exemplary screenshot of GPS Data;

FIG. 7 is an exemplary screenshot of records in a mapping database containing information for mapping intrusions;

FIG. 8 is an exemplary screenshot of records in a vulnerability database;

FIG. 9 is an exemplary screenshot of a map geographically mapping computer-originated attacks consistent with the present invention; and

FIG. 10 is a flowchart showing an exemplary method for updating a geographic map with progress information.

### DETAILED DESCRIPTION

Reference will now be made in detail to exemplary embodiments consistent with the present invention, examples of which are illustrated in the accompanying drawings. Wherever possible, the same reference numbers will be used throughout the drawings to refer to the same or like parts. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

As used herein, an “intrusion” or “threat” is an unauthorized use, attempt, or successful entry into a digital, computerized, or automated system, requiring a response from a human administrator or response team to mitigate any damage or unwanted consequences of the entry. For example, the introduction of a virus and the unauthorized entry into a system by a hacker are each “intrusions” within the spirit of the present invention. In addition, a computer-originated attack based on a GPS device is a form of an “intrusion” or “threat.” Moreover, an “intrusion response” may be a response by administrators or human operators to mitigate damage from the intrusion or prevent future intrusions. One of ordinary skill in the art will recognize that, within the spirit and scope of the present invention, “intrusions” of many types and natures are contemplated.

Likewise, as used herein, a “vulnerability” is a prospective intrusion, that is, a location in a digital, computerized, or automated system, at which an unauthorized use, attempt, or successful entry is possible or easier than at other points in the system. For example, a specific weakness may be identified in a particular operating system such as Microsoft's Windows™ operating system when running less than Service Pack 6. All GPS devices running the Windows operating system with less than Service Pack 6 will therefore have this vulnerability. One of ordinary skill in the art will recognize that this and other vulnerabilities may be identified by commercially available software products. Therefore, methods and systems of locating such vulnerabilities are within the scope and spirit of the present invention.

In addition, as used herein, a “response” or “mitigation response” is the effort undertaken to reduce unwanted consequences or to eliminate the possibility of a vulnerability or intrusion. For example, such a response may entail sending a human computer administrator to the site of the location to update software, install anti-virus software, eliminate a virus, or perform other necessary tasks. In addition, a response may entail installing a patch to the vulnerable or intruded GPS device, such as across a network. One of ordinary skill in the art will recognize that the present invention does not contemplate any specific responses. Instead, any response to a vulnerability or intrusion requiring the organization of resources is within the scope and spirit of the present invention.

Furthermore, as used herein, a “system” refers to a single item or a regularly interacting or interdependent group of items forming a unified whole. For example, a “mapping system” may be a computer, server, a plurality of computers or servers, or a combination of computers and servers. One of ordinary skill in the art will recognize that, within the spirit and scope of the present invention, “systems” of many types and natures are contemplated.

The term “computer-readable medium” or “computer readable medium” as used herein refers to any media that participates in providing instructions to a computer processor for execution. Such a medium may take many forms, including but not limited to, non-volatile, volatile media, and transmission media. Non-volatile media includes storage devices such as optical or magnetic disks. Volatile media includes dynamic memory such as a random access memory (RAM). Transmission media includes coaxial cables, copper wire and fiber optics. Transmission media may also take the form of acoustic or light waves such as those generated during radio-wave and infra-red data communications.

Common forms of computer-readable media include, for example, a floppy disk, flexible disk, hard disk, magnetic tape or any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer may read. For the purposes of this discussion, carrier waves are the signals which carry the data to and from a computer.

The term “database” as used herein refers to a collection of data organized for search and retrieval. A database may be implemented using a relational database scheme, and/or may be built using Microsoft Access™ or Microsoft Excel™ software. Moreover, a database may take many forms, including, but not limited to, text file, Microsoft Excel™ spreadsheet, Oracle™ database, IBM DB2™, Microsoft SQL Server™, and/or data warehouse. One of ordinary skill in the art will recognize that any implementation (and location) of the databases described herein is contemplated within the scope and spirit of the present invention.

As used herein, the term “GPS device” refers to any computing device equipped with a GPS receiver. For example, a GPS device could be a PDA, a Smartphone, or a laptop with embedded or integrated GPS capabilities. One of ordinary skill in the art will recognize that “GPS devices” of many types and natures are contemplated within the scope and spirit of the present invention.

Finally, as used herein, the term “displaying a geographical location” includes, but not limited to, using a basic pushpin mapping or demographic data mapping, where the data would then be displayed on a map. The term “displaying a geographical location” further includes, but not limited to, continually updating the map based on the intrusion or vulnerability data.

For the ease of discussion, the following discussion will discuss primarily systems and methods consistent with the present invention in terms of mapping “intrusions.” However, these same systems and methods are equally applicable to mapping “vulnerabilities,” as shown in several embodiments consistent with the present invention.

### System Environment

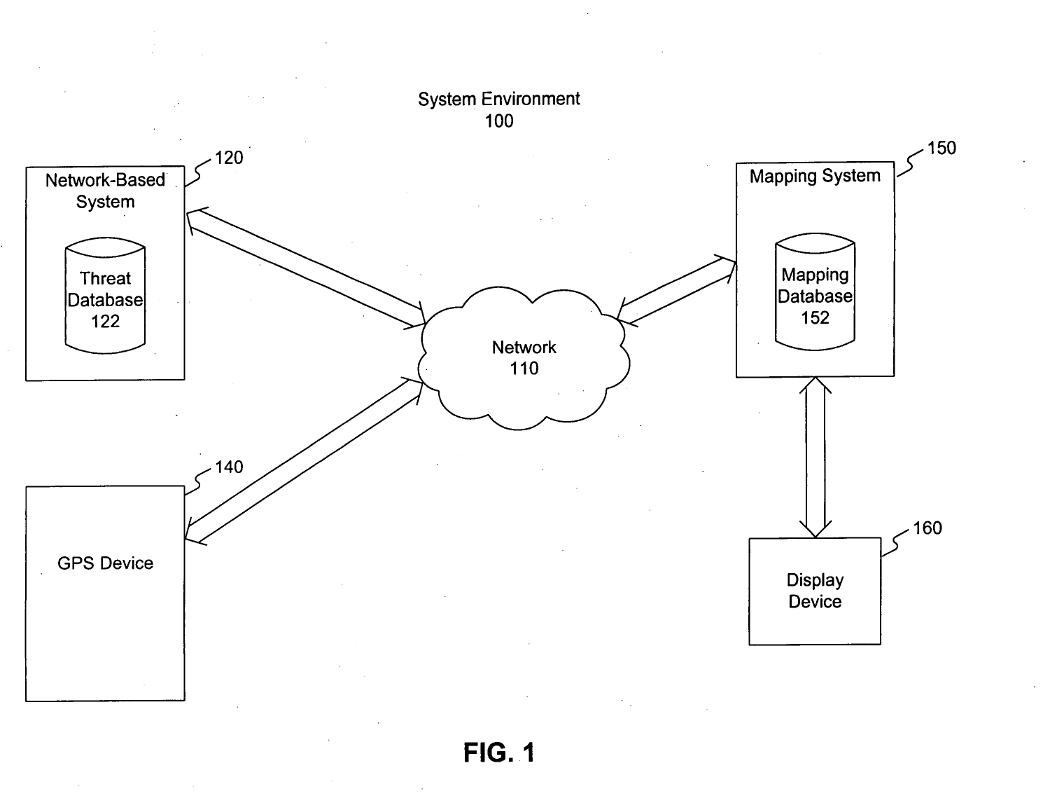

FIG. 1 is a block diagram of one exemplary environment 100, in which the systems and methods consistent with the present invention may be implemented. The number of components in environment 100 is not limited to what is shown and other variations in the number of arrangements of components are possible, consistent with embodiments of the invention. The components of FIG. 1 may be implemented through hardware, software, and/or firmware.

As shown in FIG. 1, environment 100 may include a network-based system 120 and a mapping system 150, each directly or indirectly in electronic communication with the other system(s). In one embodiment, such communication is conducted through a network 110. Network 110 may be implemented through a local area network (“LAN”), a wide area network (“WAN”), or any other network configuration. Environment 100 also includes a display device 160, such as a video display, for displaying the geographical intrusion information correlated and mapped by the mapping system 150 using the methods discussed herein.

In addition environment 100 may include a GPS device 140, from which the threat system 120 and/or mapping system 150 receives GPS data in a format such as NMEA 0183 via software transmitting this data using TCP or UDP. One of ordinary skill in the art will recognize that GPS device 140 may communicate with threat system 120 and/or mapping system 150 via one or more data transmission capabilities or software.

In one embodiment, network-based system 120 includes threat database 122, which may contain Intrusion Detection System (“IDS”) or Firewall logs identifying a threat in the system. For example, IDS or Firewall logs may contain the attack type, description, and impacted GPS device information such as an IP Address of the impacted GPS device. In addition, GPS device 140 is capable of providing information such as the IP address and geographic coordinates (e.g., latitude and longitude) of the device. Finally, mapping system 150 includes mapping database 152, which may correlate and contain data from threat database and GPS device(s), as described below, to map the intrusion(s).

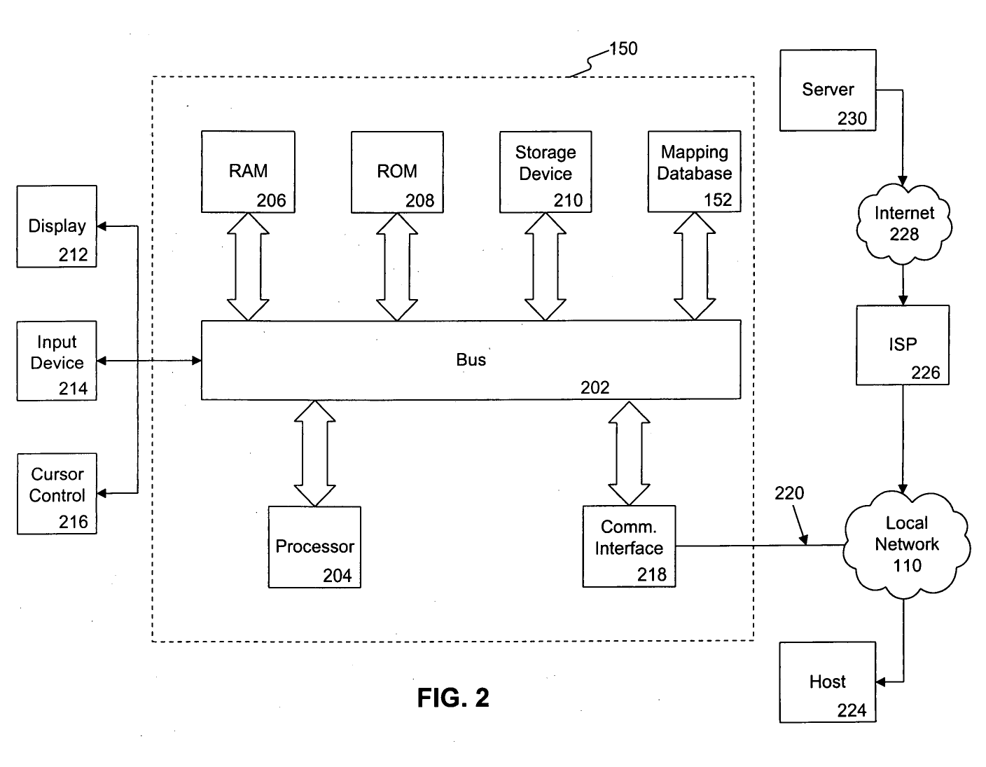

FIG. 2 is a block diagram illustrating an exemplary mapping system 150 for use in environment 100, consistent with the present invention. In one embodiment, mapping system 150 may be a computer, which includes a bus 202 or other communication mechanism for communicating information, and a processor 204 coupled to bus 202 for processing information. Mapping system 150 also includes a main memory, such as a RAM 206, coupled to bus 202 for storing information and instructions during execution by processor 204. RAM 206 also may be used for storing temporary variables or other intermediate information during execution of instructions to be executed by processor 204. Mapping System 150 further includes a read only memory (ROM) 208 or other storage device coupled to bus 202 for storing static information and instructions for processor 204. A mass storage device 210, such as a magnetic disk or optical disk, is provided and coupled to bus 202 for storing information and instructions. Finally, a mapping database 152, also shown in FIG. 1, is provided and coupled to bus 202 for storing map data to be retrieved for displaying geographical location of the intrusion(s).

Mapping system 150 may be coupled via bus 202 to a display 212, such as a cathode ray tube (CRT), for displaying information to an intrusion response team. Display 212 may, in one embodiment, operate as display device 160 (see FIG. 1). Mapping system 150 may further be coupled to an input device 214, such as a keyboard, is coupled to bus 202 for communicating information and command selections to processor 204. Another type of user input device is a cursor control 216 such as a mouse, a trackball or cursor direction keys for communicating direction information and command selections to processor 204 and for controlling cursor movement on display 212. Cursor control 216 typically has two degrees of freedom in two axes, a first axis (e.g., x) and a second axis (e.g., y), which allow the device to specify positions in a plane.

According to one embodiment, mapping system 150 executes instructions for geographical mapping of vulnerability or intrusion information for a computer-originated attack. Either alone or in combination with another computer system, mapping system 150 thus permits identification of the geographical location of one or more computer-originated attacks in response to processor 204 executing one or more sequences of instructions contained in RAM 206. Such instructions may be read into RAM 206 from another computer-readable medium such as storage device 210. Execution of the sequences of instructions contained in RAM 206 causes processor 204 to perform the functions of mapping system 150 and/or the process stages described herein. In an alternative implementation, hard-wired circuitry may be used in place of, or in combination with, software instructions to implement the invention. Thus, implementations consistent with the principles of the present invention are not limited to any specific combination of hardware circuitry and software.

Various forms of computer-readable media may be involved in carrying one or more sequences of one or more instructions to processor 204 for execution. For example, the instructions may initially be carried on the magnetic disk of a remote computer. The remote computer may load the instructions into a dynamic memory and send the instructions over a telephone line using a modem. A modem local to mapping system 150 may receive the data on the telephone line and use an infra-red transmitter to convert the data to an infra-red signal. An infra-red detector coupled to bus 202 may receive the data carried in the infra-red signal and place the data on bus 202. Bus 202 carries the data to main memory 206, from which processor 204 retrieves and executes the instructions. The instructions received by main memory 206 may optionally be stored on storage device 210 either before or after execution by processor 204.

Mapping system 150 may also include a communication interface 218 coupled to bus 202. Communication interface 218 provides a two-way data communication coupling to a network link 220 that may be connected to network 110. For example, communication interface 218 may be an integrated services digital network (ISDN) card or a modem to provide a data communication connection to a corresponding type of telephone line. Mapping system 150 may communicate with a host 224 via network 110. In another example, communication interface 218 may be a LAN card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. In this embodiment, network 110 may communicate with an Internet Service Provider (ISP) 226. For example, network link 220 may provide a connection to data equipment operated by ISP 226. ISP 226, in turn, may provide data communication services from another server 230 or host 224 to mapping system 150. Network 110 may use electric, electromagnetic or optical signals that carry digital data streams.

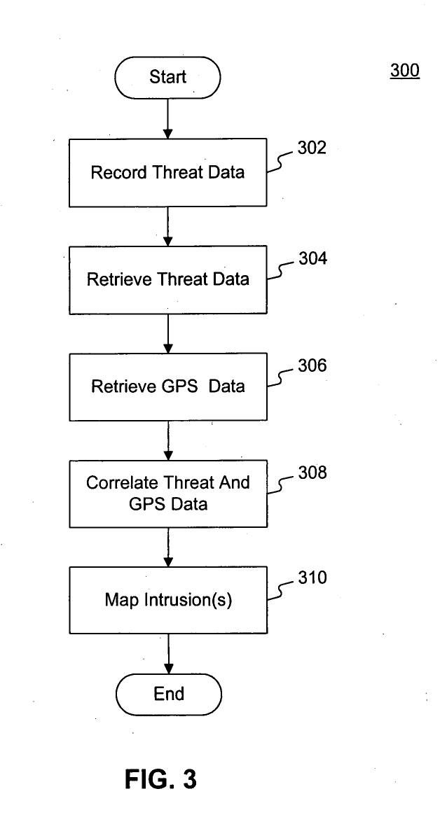

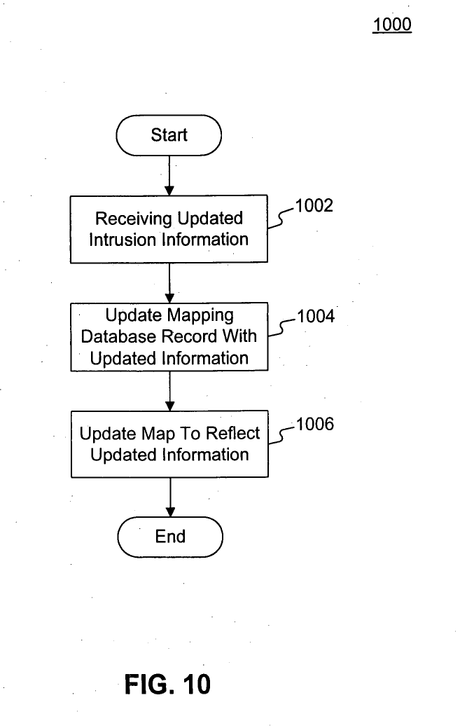

Mapping system 150 may send messages and receive data, including program code, through network 110, network link 220 and communication interface 218. In this embodiment, server 230 may download an application program to mapping system 150 via network 110 and communication interface 218. Consistent with the present invention, one such downloaded application geographically maps vulnerability or intrusion information, for example, by executing methods 300 and/or 1000, to be described below in FIG. 3 and FIG. 10. The received code may be executed by processor 204 as it is received and/or stored in storage device 210 or other non-volatile storage for later execution.

Although mapping system 150 is shown in FIG. 2 as connectable to server 230, those skilled in the art will recognize that mapping system 150 may establish connections to multiple servers on Internet 228 and/or network 110. Such servers may include HTML-based Internet applications to provide information to mapping system 150 upon request in a manner consistent with the present invention.

Returning to FIG. 1, display device 160 may, in one embodiment, be implemented as display 212 in FIG. 2, directly connected to mapping system 150. In an alternative embodiment, display device 160 may be connected to mapping system 150 via network 110. For example, display device 160 may be a display connected to another computer on network 110, or may be a stand-alone display device such as a video projector connected to mapping system 150 via network 110.

Similarly, network-based system 120 and GPS device 140 may be connected to mapping system 150 directly or indirectly and with or without network 110. One of ordinary skill in the art will recognize that any implementation (and configuration) of the system environment described herein is contemplated within the scope and spirit of the present invention. For example, network-based system 120 may reside within mapping system 150 or may reside in any other location, such as on network 110, so long as it is in electronic communication with mapping system 150.

In one embodiment, databases 122 and 152 may be implemented as a single database, or may be implemented as any number of databases. For example, one of ordinary skill in the art will recognize that environment 100 may include multiple threat and mapping databases. One of ordinary skill in the art will also recognize that environment 100 may include any number of databases so long as the information discussed herein may be retrieved and correlated as discussed herein. Finally, databases 122 and 152 may be implemented using any now known or later developed database schemes or database software.

### Locating Sources of Computer-Originated Attacks

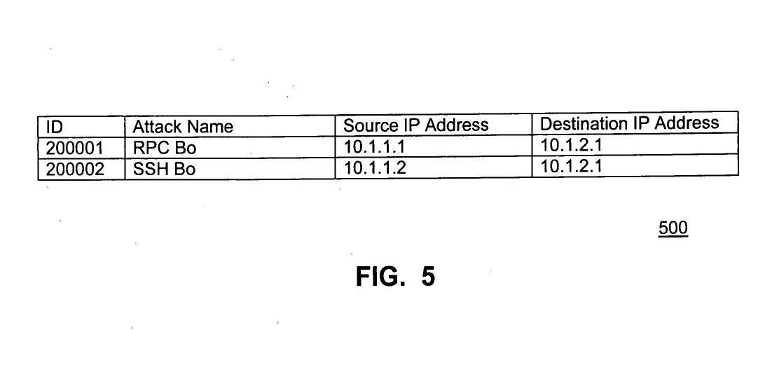

FIG. 3 shows a method 300 consistent with the present invention, which may be performed by mapping system 150, to locate sources of computer-originated attacks based on GPS devices. Method 300 begins by recording threat data at stage 302. Threat data may be any information describing or identifying a threat. They could, for example, come from a computer administrator, from the output of software designed to detect or discover intrusions from IDS or Firewall logs, from a network management system, from a security information manager, or from any other source. In one embodiment, the threat data may include an identification (such as the IP address) of the GPS device or network point where the computer-originated attack started, and the name and description of the attack event, among other information. The threat data are stored in threat database 122. Mapping system 150 then retrieves the threat data from threat database 122 at stage 304. FIG. 5 shows one embodiment of threat data 500 within threat database 122.

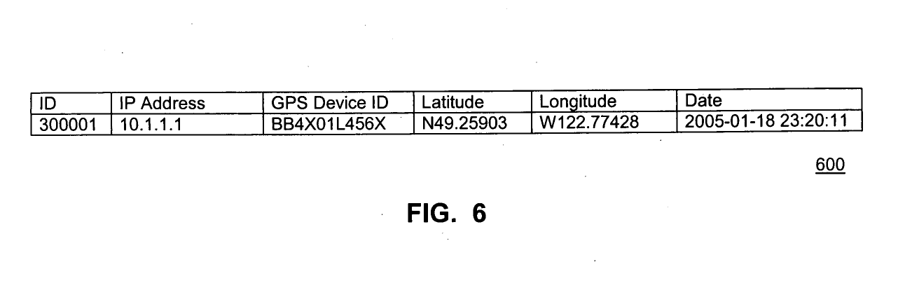

Returning to FIG. 3, mapping system 150 retrieves GPS data, for GPS devices at which the computer-originated attack(s) started at stage 306. In one embodiment, at least one part of the threat data (such as the IP address) may be used as a key to retrieve the appropriate GPS record(s). The GPS data may include IP address and location information, such as geographic coordinates, of the GPS device at which the computer-originated attack(s) started, as necessary. FIG. 6 shows one exemplary embodiment of the GPS data 600 from GPS device 140.

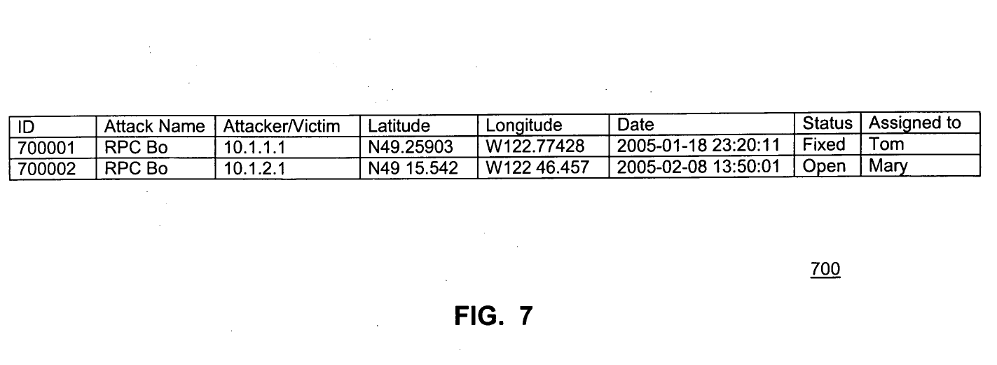

Once the relevant data have been retrieved from threat database 122 and GPS device 140, they may be stored in mapping system 150. At stage 308, the retrieved data are preferably correlated such that all information for a particular computer-originated attack is stored in a record or records for that crime. In one embodiment, the correlated data are stored as map data in mapping database 152. FIG. 7 shows an exemplary screenshot 700 of records in mapping database 152. As shown, mapping database records may contain attack event name, the network address (such as the IP address from threat database 122), and the physical location such as geographic coordinates (from GPS device 140). In addition, mapping database records may also include a status of the intrusion and an indication of the response person or team assigned to respond to the intrusion.

Returning to FIG. 3, at stage 310, mapping system 150 maps the location of the source of the computer-originated attack. In one embodiment, the map data for each computer-originated attack are imported into a commercially available mapping program such as Microsoft MapPoint™ to visually locate the intrusion points on a map presented on display 212.

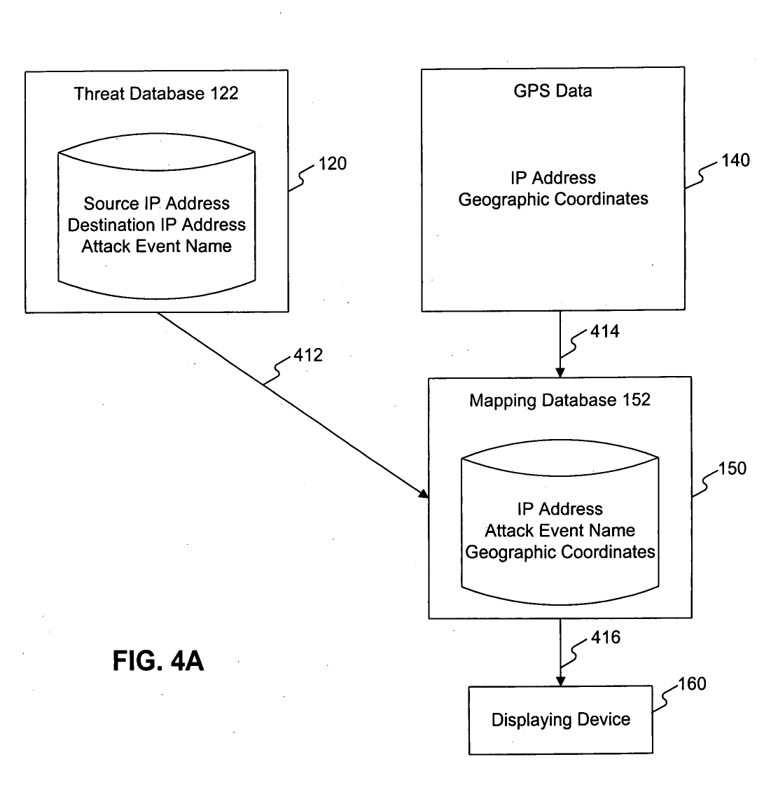

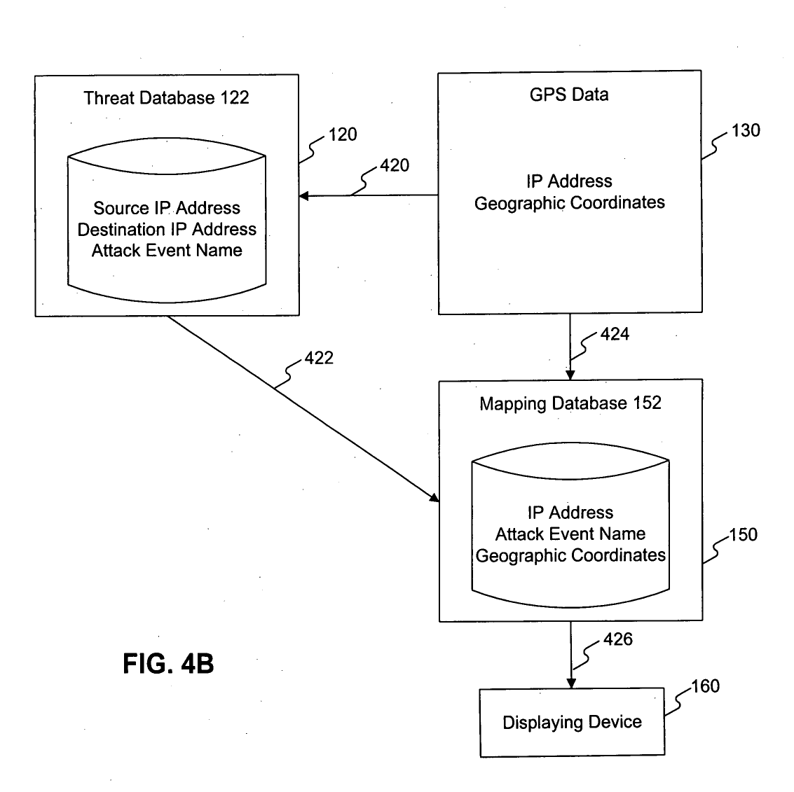

FIGS. 4A and 4B are block diagrams showing two exemplary methods for locating a source of a computer-originated attack based on a GPS device, both of which are consistent with the invention.

In FIG. 4A, mapping system 150 receives, from threat database 122 in network-based system 120, threat data containing, for example, source IP address, destination IP address, and attack event name, at stage 412. In addition, at stage 414, mapping system 150 receives GPS data from GPS device 140. GPS data contains, for example, IP address and geographic coordinates of the impacted GPS device. One of ordinary skill in the art will recognize that these stages, namely, 412 and 414, may take place simultaneously or in any sequences.

After receiving threat and GPS data, mapping system 150 correlates threat data with GPS data to generate map data. In one embodiment, mapping system 150 joins tables from threat database 122 with GPS data, utilizes IP address in GPS data as a key to identify the record(s) indicating the source of the intrusion or computer-originated attack from threat database 122, and generates map data containing IP address, attack event name, and geographic coordinates in mapping database 152. One of ordinary skill in the art will recognize that this correlation may be implemented in many ways.

At stage 416, mapping system 150 generates a map displaying a geographical location of the source of the intrusion(s) or computer-originated attack(s) based on the map data from mapping database 152.

In another embodiment, FIG. 4B shows an exemplary method consistent with the invention where the network-based system communicates directly with the GPS device.

In FIG. 4B, network-based system 120 receives GPS data describing or identifying the impacted GPS device from GPS device 140 at stage 420. Also at stage 420, network-based system 120 queries the table(s) in threat database 122, utilizing the IP address of GPS data as a key to identify the record(s) describing or identifying the computer-originated attack(s) from threat database 122.

Next, mapping system 150 receives threat data describing or identifying the computer-originated attack(s) from threat database 122 at stage 422 and GPS data from GPS device 140 at stage 424. Mapping system 150 further correlates threat data with GPS data and generates map data containing IP address, attack event name, and geographic coordinates in mapping database 152. In one embodiment, the correlation is implemented by matching the IP addresses between GPS data and threat data. However, one of ordinary skill in the art will recognize that this correlation may be implemented in many ways.

At stage 426, mapping system 150 generates a map displaying geographical location of the source of the intrusion(s) or computer-originated attack(s) based on the map data from mapping database 152.

### Locating Vulnerabilities Susceptible to Computer-Originated Attacks

As mentioned earlier, while the discussion herein refers to primarily systems and methods consistent with the present invention in terms of mapping “intrusions,” these same systems and methods are equally applicable to mapping “vulnerabilities.”

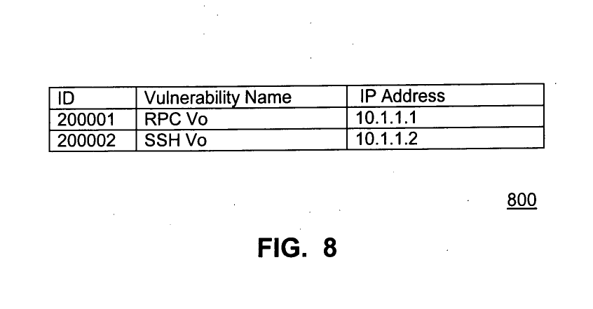

For example, in FIG. 1, network-based system 120 may include a vulnerability database instead of, or in addition to, threat database 120. Furthermore, while method 300 in FIG. 3 is an exemplary method to locate a source of a computer-originated attack based on a GPS device, a similar method may locate the vulnerability susceptible to a computer-originated attack based on a GPS device. In particular, such a method may include recording vulnerability data, retrieving vulnerability data and GPS data, and correlating vulnerability data with GPS data to create map data. Vulnerability data may be any information describing or identifying a GPS device vulnerable to a computer-originated attack. Vulnerability data may, for example, contain IP address, or vulnerability name. FIG. 8 shows one embodiment of vulnerability data 800.

Moreover, in FIG. 4A, network-based system 120 may include a vulnerability database containing IP address, or vulnerability name. Mapping system 150 may receive vulnerability data from the vulnerability database in network-based system 120 and GPS data from GPS device 140. Mapping system 150 then correlates vulnerability data with GPS data to generate map data.

Similarly, in FIG. 4B, network-based system 120 may include a vulnerability database containing IP address or vulnerability name. In addition, network-based system 120 may receive GPS data from GPS device 140 and then query vulnerability database 122 by providing GPS data. Mapping system 150, on the other hand, may receive vulnerability data from the vulnerability database in network-based system 120 and the queried GPS data from GPS device 140. Mapping system 150 then correlates vulnerability data with GPS data to generate map data.

One of ordinary skill in the art, therefore, will recognize that systems and methods consistent with the present invention may be applied to both mapping intrusions and mapping vulnerabilities.

### Displaying Geographical Location(s) of the Intrusion(s)

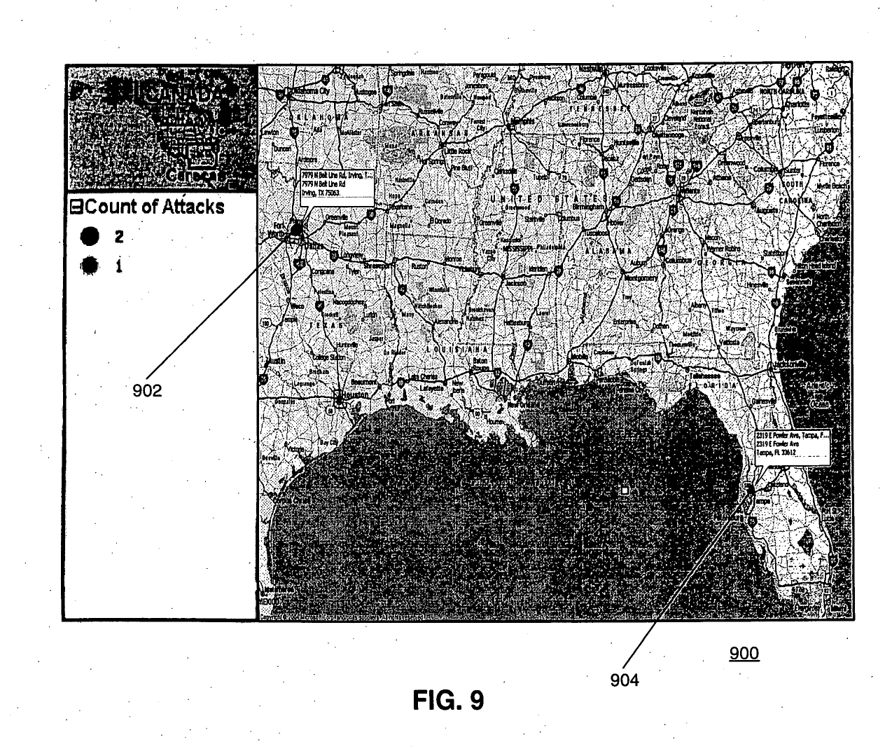

Returning to FIG. 3, as discussed above, mapping system 150 maps the location of the source of each intrusion or computer-originated attack at stage 310. The map data for each intrusion may be imported into a commercially available mapping program such as Microsoft MapPoint™ to visually locate the intrusion points on a map. In one embodiment, the map may represent each of the intrusions as a symbol on the map, for example, as a “pushpin.” An exemplary map 900 using this pushpin approach is shown in FIG. 9. Within map 900, each pushpin symbol 902, 904, shows the location of a point of intrusion or vulnerability requiring a response.

Using map 900, response teams will be able to identify “pockets” of intrusions and will be able to better prioritize and more efficiently schedule response personnel to respond and mitigate or eliminate the intrusions, based on geographical location. For example, the color of the pushpin symbol or representation on the map may be used to identify the quantity of intrusions or vulnerable points in an area on the map, allowing the administrators to identify such “pockets.” In addition, the symbol (i.e., pushpin or other symbol) may be linked to the underlying data. In this manner, a system user may, using an input device, select a symbol on the map to initiate a display of data such as the intrusion type, IP address, status of the response, or other information.

FIG. 10 shows a flowchart of a method 1000, consistent with the invention, for updating the geographical map with progress information, if required. Method 1000 begins at stage 1002 where a response team sends an update to the system to advise of a new status of an intrusion or environment 100 captures new information regarding an intrusion. Common status conditions are: the intrusion or attack has stopped, the response team determines that the intruded or attacked device must be replaced and be rendered inactive until it is replaced (i.e., the intrusion is “open”), or the response team may advise the system that the intruded device has been upgraded and is no longer compromised.

Once this information is received, the mapping database record for the identified intrusion is updated at stage 1004. For example, each intrusion record in the database may contain a field to identify the status of the intrusion (see FIG. 7). Possible status indicators may reflect that the intrusion is “new,” “open” (i.e., not yet responded to), “assigned to a response team,” “closed” (i.e., responded to and fixed), or any other status that may be of use to the organization to send appropriate process or human resources.

Once the mapping database records have been updated, mapping system 150 can update map 900 to reflect the updated status of the intrusion at stage 1006. For example, one way that map 900 can show the status information is to display color-coded pushpin symbols to reflect the status. In one embodiment, a red pushpin may signify an “open” or “new” intrusion; a yellow pushpin may signify a intrusion that has been assigned, but not yet fixed; and a green pushpin may signify a closed intrusion. By mapping this information together with the locations of the intrusion, administrators can better track the progress of their response teams, and more fluidly schedule responses to new intrusion as they arise.

One of ordinary skill in the art will recognize that any symbol or representation may be used to identify an intrusion on the map, including, but not limited to, a pushpin symbol. These symbols and representations may be used to identify the quantity of intrusions in that area of the map such as by varying the color of the symbol to identify such quantity. In addition, the symbol or representation may be linked to the underlying data such that a user, using an input device, may select a symbol on the map causing mapping system 150 to display the status, quantity, address, or other information corresponding to the selected symbol.

Finally, one of ordinary skill in the art will recognize that map 900 and method 1000 may be modified to display geographical locations of the vulnerabilities susceptible to computer-originated attacks based on GPS devices. In addition, other methods and systems consistent with the invention may display geographical locations of both the vulnerabilities and the intrusions at the same time.

While the present invention has been described in connection with various embodiments, other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for locating a source of a computer-originated attack based on a GPS device, comprising:
receiving threat data;
retrieving GPS data;
correlating the threat data with the GPS data to generate map data; and
generating a map displaying a geographical location of the source of the computer-originated attack based on the map data.

2. The method of claim 1, wherein the threat data comprises source IP address, destination IP address, and attack event name.

3. The method of claim 1, wherein the GPS data comprises IP address and geographic coordinates.

4. The method of claim 3, wherein:
the threat data comprises source IP address, destination IP address, and attack event name; and
correlating comprises correlating the IP address of the GPS data with the source IP address of the threat data.

5. The method of claim 3, wherein:
the threat data comprises source IP address, destination IP address, and attack event name; and
correlating comprises correlating the IP address of the GPS data with the destination IP address of the threat data.

6. The method of claim 1, wherein retrieving comprises querying the threat data by providing the GPS data.

7. The method of claim 6, wherein the GPS data comprises IP address and geographic coordinates.

8. The method of claim 7, wherein:
the threat data comprises source IP address, destination IP address, and attack event name; and
querying comprises correlating the IP address of the GPS data with the source IP address of the threat data.

9. The method of claim 7, wherein:
the threat data comprises source IP address, destination IP address, and attack event name; and
querying comprises correlating the IP address of the GPS data with the destination IP address of the threat data.

10. A method for locating a vulnerability susceptible to a computer-originated attack based on a GPS device, comprising:
receiving vulnerability data;
retrieving GPS data;
correlating the vulnerability data with the GPS data to generate map data; and
generating a map displaying a geographical location of the vulnerability based on the map data.

11. The method of claim 10, wherein the vulnerability data comprises IP address and vulnerability name.

12. The method of claim 10, wherein the GPS data comprises IP address and geographic coordinates.

13. The method of claim 12, wherein:
the vulnerability data comprises IP address and vulnerability name; and
correlating comprises correlating the IP address of the GPS data with the IP address of the vulnerability data.

14. The method of claim 10, wherein retrieving comprises querying the vulnerability data by providing the GPS data.

15. The method of claim 14, wherein the GPS data comprises IP address and geographic coordinates.

16. The method of claim 15, wherein:
the vulnerability data comprises IP address and vulnerability name; and
querying comprises correlating the IP address of the GPS data with the IP address of the vulnerability data.

17. A mapping system for locating a source of a computer-originated attack based on a GPS device, comprising:
means for receiving threat data;
means for retrieving GPS data;
means for correlating the threat data with the GPS data to create map data to generate map data; and
means for generating a map displaying a geographical location of the source of the computer-originated attack based on the map data.

18. The mapping system of claim 17, wherein the threat data comprises source IP address, destination IP address, and attack event name.

19. The mapping system of claim 17, wherein the GPS data comprises IP address and geographic coordinates.

20. The mapping system of claim 19, wherein:
the threat data comprises source IP address, destination IP address, and attack event name; and
correlating comprises correlating the IP address of the GPS data with the source IP address of the threat data.

21. The mapping system of claim 19, wherein:
the threat data comprises source IP address, destination IP address, and attack event name; and
correlating comprises correlating the IP address of the GPS data with the destination IP address of the threat data.

22. A mapping system for locating a vulnerability susceptible to a computer-originated attack based on a GPS device, comprising:
means for receiving vulnerability data;
means for retrieving GPS data;
means for correlating the vulnerability data with the GPS data to create map data to generate map data; and
means for generating a map displaying a geographical location of the vulnerability based on the map data.

23. The mapping system of claim 22, wherein the vulnerability data comprises IP address and vulnerability name.

24. The mapping system of claim 22, wherein the GPS data comprises IP address and geographic coordinates.

25. The mapping system of claim 24, wherein:
the vulnerability data comprises IP address and vulnerability name; and
correlating comprises correlating the IP address of the GPS data with the IP address of the vulnerability data.

26. A system for locating a source of a computer-originated attack based on a GPS device, comprising:
a network-based system configured to provide threat data;
a GPS device configured to provide GPS data;
a mapping system configured to receive the threat data and the GPS data, generate map data by correlating the threat data with the GPS data, and generate a map reflecting a geographical location of the source of the computer-originated attack based on the map data; and
a display device configured to communicate with the mapping system for displaying the generated map.

27. The system of claim 26, wherein the threat data comprises source IP address, destination IP address, and attack event name.

28. The system of claim 26, wherein the GPS data comprises IP address and geographic coordinates.

29. The system of claim 28, wherein:
the threat data comprises source IP address, destination IP address, and attack event name; and
the mapping system is further configured to correlate the IP address of the GPS data with the source IP address of the threat data.

30. The system of claim 28, wherein:
the threat data comprises source IP address, destination IP address, and attack event name; and
the mapping system is further configured to correlate the IP address of the GPS data with the destination IP address of the threat data.

31. The system of claim 26, wherein the network-based system is capable of receiving the GPS data from the GPS device.

32. The system of claim 31, wherein the GPS data comprises IP address and geographic coordinates.

33. The system of claim 32, wherein:
the threat data comprises source IP address, destination IP address, and attack event name; and
the network-based system is further configured to correlate the IP address of the GPS data with the source IP address of the threat data.

34. The system of claim 32, wherein:
the threat data comprises source IP address, destination IP address, and attack event name; and
the network-based system is further configured to correlate the IP address of the GPS data with the destination IP address of the threat data.

35. A system for locating a vulnerability susceptible to a computer-originated attack based on a GPS device, comprising:
a network-based system configured to provide vulnerability data;
a GPS device configured to provide GPS data;
a mapping system configured to receive the vulnerability data and the GPS data, generate map data by correlating the vulnerability data with the GPS data, and generate a map, based on the map data, reflecting a geographical location of the vulnerability; and
a display device configured to communicate with the mapping system for displaying the generated map.

36. The system of claim 35, wherein the vulnerability data comprises IP address and vulnerability name.

37. The system of claim 35, wherein the GPS data comprises IP address and geographic coordinates.

38. The system of claim 37, wherein:
the vulnerability data comprises IP address and vulnerability name; and
the mapping system is further configured to correlate the IP address of the GPS data with the IP address of the vulnerability data.

39. The system of claim 35, wherein the network-based system is capable of receiving the GPS data from the GPS device.

40. The system of claim 39, wherein the GPS data comprises IP address and geographic coordinates.

41. The system of claim 40, wherein:
the vulnerability data comprises IP address and vulnerability name; and
the network-based system is further configured to correlate the IP address of the GPS data with the IP address of the vulnerability data.

42. A computer readable medium containing instructions, which, when executed by a processor, perform a method for locating a source of a computer-originated attack, the method comprising:
receiving threat data;
retrieving GPS data;
correlating the threat data with the GPS data to generate map data; and
generating a map displaying a geographical location of the source of the computer-originated attack based on the map data.

43. The computer readable medium of claim 42, wherein the threat data comprises source IP address, destination IP address, and attack event name.

44. The computer readable medium of claim 42, wherein the GPS data comprises IP address and geographic coordinates.

45. The computer readable medium of claim 44, wherein:
the threat data comprises source IP address, destination IP address, and attack event name; and
correlating comprises correlating the IP address of the GPS data with the source IP address of the threat data.

46. The computer readable medium of claim 44, wherein:
the threat data comprises source IP address, destination IP address, and attack event name; and
correlating comprises correlating the IP address of the GPS data with the destination IP address of the threat data.

47. The computer readable medium of claim 42, wherein retrieving comprises querying the threat data by providing the GPS data;

48. The computer readable medium of claim 47, wherein the GPS data comprises IP address and geographic coordinates.

49. The computer readable medium of claim 48, wherein:
the threat data comprises source IP address, destination IP address, and attack event name; and
querying comprises correlating the IP address of the GPS data with the source IP address of the threat data.

50. The computer readable medium of claim 48, wherein:
the threat data comprises source IP address, destination IP address, and attack event name; and
querying comprises correlating the IP address of the GPS data with the destination IP address of the threat data.

51. A computer readable medium containing instructions, which, when executed by a processor, perform a method for locating a vulnerability susceptible to a computer-originated attack based on a GPS device, comprising:
receiving vulnerability data;
retrieving GPS data;
correlating the vulnerability data with the GPS data to generate map data; and
generating a map displaying a geographical location of the vulnerability based on the map data.

52. The computer readable medium of claim 51, wherein the vulnerability data comprises IP address and vulnerability name.

53. The computer readable medium of claim 51, wherein the GPS data comprises IP address and geographic coordinates.

54. The computer readable medium of claim 53, wherein:
the vulnerability data comprises IP address and vulnerability name; and
correlating comprises correlating the IP address of the GPS data with the IP address of the vulnerability data.

55. The computer readable medium of claim 53, wherein retrieving comprises querying the vulnerability data by providing the GPS data;

56. The computer readable medium of claim 55, wherein the GPS data comprises IP address and geographic coordinates.

57. The computer readable medium of claim 56, wherein:
the vulnerability data comprises IP address and vulnerability name; and
querying comprises correlating the IP address of the GPS data with the IP address of the vulnerability data.
